(19) United States
(12) Patent Application Publication
(10) Pub. No.: US 2006/0087587 A1
(43) Pub. Date: Apr. 27, 2006

(54) Video signal generator generating monochrome signal without color noise

(75) Inventor: Takeshi Goto, Tokyo (JP)

Correspondence Address: NIXON PEABODY, LLP, 401 9TH STREET, NW, SUITE 900, WASHINGTON, DC, 20004-2128, US

(73) Assignee: Oki Electric Industry Co., Ltd., Tokyo (JP)

(21) Appl. No.: 11/228,228

(22) Filed: Sep. 19, 2005

(30) Foreign Application Priority Data
Oct. 27, 2004 (JP) 2004-311922

(51) Int. Cl. H04N 5/04

(52) U.S. Cl. 348/501; 348/571

(57) ABSTRACT

A video signal generator adds a digital luminance signal to a digital chrominance signal including a color burst to obtain a digital composite video signal. A selector selects the digital luminance signal for a monochrome picture and the digital composite video signal for a color picture. A digital-to-analog converter converts the selected signal to an analog signal, which is output from a composite video output terminal. The selection may be made by comparing the digital chrominance signal with a threshold to decide whether the digital luminance and chrominance signals represent a monochrome picture or a color picture. For a monochrome picture, the output signal includes no color burst and is free of color noise. A receiving device can reproduce the monochrome picture faithfully without the need for a separate-video input connector or color burst suppression circuitry.

### BACKGROUND OF THE INVENTION

1. Field of the Invention

The present invention relates to a circuit for generating an analog composite video signal from a digital video signal.

2. Description of the Related Art

Circuits that generate an analog composite video signal from a digital video signal are found, for example, in integrated circuits used as components of digital video encoders with analog as well as digital output terminals. A composite video signal includes a luminance component and a chrominance component, which are preceded in each horizontal scanning line by a color burst. The digital chrominance component and color burst are modulated onto a color subcarrier, then added to the digital luminance component, which is given a suitable timing phase adjustment delay. The resulting combined digital signal is converted to analog form for output at a single composite video output terminal, from which the analog output signal may be supplied to a device such as a color monitor or video cassette recorder designed to receive an analog composite video signal.

The color burst is always present, even when the composite video signal represents a monochrome picture and the chrominance component is in principle absent. When the chrominance component is present, the receiving device processes it separately from the luminance component, using the color burst for phase synchronization with the chrominance component.

A problem with the conventional analog composite video signal is that when the signal represents a monochrome picture, even though there should be no chrominance component, the color subcarrier in the received signal is normally modulated to some extent by various forms of color noise. Specific examples include chrominance-to-luminance crosstalk noise or cross-color noise, and color dot crawl noise. The receiver, detecting the color burst, proceeds with luminance-chrominance separation and chrominance signal processing, processes the noise, and produces a monochrome picture tinged with unwanted color artifacts.

Japanese Patent Application Publication No. 2004-80137 proposes the following method of dealing with color noise in digital video signals. A video transmitting device connected to a digital communication channel such as an optical fiber loop includes a video encoder that can discriminate between monochrome and color input from a video camera etc. When a monochrome input signal is detected, the transmitting device sends a corresponding detection signal together with the output digital video signal. A separate commanding device, also connected to the communication channel, receives the detection signal and generates a color burst suppression instruction signal, which it feeds into the communication channel. A receiving device connected to the communication channel includes a video decoder that responds to the color burst suppression instruction signal by suppressing the color burst in the received video signal to obtain a monochrome video signal that is free of color noise.

This method could be adapted for use with analog video signals, but it suffers from problems of complexity and inconvenience. The video encoder requires extra circuitry to detect monochrome input and generate and output a monochrome detection signal. A separate commanding device must be provided. The video decoder requires extra circuitry to process the color burst suppression instruction and suppress the color burst. A receiving device lacking this type of video decoder obtains no benefit from the color burst suppression instruction.

A simpler method, well known in the analog video art, is to have the transmitting and receiving devices send and receive the luminance and chrominance signals separately, but this method requires a special S-video (separate-video) cable and connector with different conductors and pins for the two signals, and does not work with a receiving device lacking an S-video connector.

It would be desirable to have a simpler method of obtaining a color-noise-free monochrome signal from an ordinary composite video signal.

### SUMMARY OF THE INVENTION

An object of the present invention is accordingly to provide a video signal generator that can generate an analog video signal either with or without a color burst for selective output from a single composite video signal output terminal.

The invented video signal generator has an adder that adds a digital luminance signal to a digital chrominance signal including a color burst to obtain a digital composite video signal. A selector receives the digital luminance signal, the digital composite video signal, and a control signal selecting monochrome or color output. When the control signal selects monochrome output, the selector outputs the digital luminance signal; when the control signal selects color output, the selector outputs the digital composite video signal. A digital-to-analog converter converts the signal output from the selector to an analog signal, which is supplied to a composite video output terminal.

The video signal generator may also include a decision circuit that measures the strength of the color components in the digital chrominance signal; decides, by comparing the measured strength with a threshold, for example, whether the digital chrominance signal represents a color picture or a monochrome picture; and sets the control signal accordingly.

By use of a simple selector, the invented video signal generator can output an analog composite video signal that, when representing a color picture, includes the normal color burst and luminance and chrominance components, and when representing monochrome picture, includes only the luminance component. This scheme eliminates the need for output and transmission of a monochrome detection signal and color burst suppression command. For monochrome pictures, a receiving device obtains a color-noise-free video signal without requiring an S-video input connector or extra color burst suppression circuitry.

### BRIEF DESCRIPTION OF THE DRAWINGS

In the attached drawings:

FIG. 1 illustrates the waveform of a composite video signal representing a color picture;

FIG. 2 illustrates the waveform of a composite video signal representing a monochrome picture;

FIG. 3 is a block diagram of a video signal generator according to a first embodiment of the invention;

FIG. 4 is a block diagram of the color burst signal synthesizer in FIG. 3;

FIG. 5 is a block diagram of the selector control signal generator in FIG. 3;

FIG. 6 is a block diagram of a luminance/chrominance separation circuit in a receiving device;

FIG. 7 illustrates the waveform of a composite video signal, representing a monochrome picture, without a color burst;

FIG. 8 is a block diagram of a video signal generator according to a second embodiment of the invention;

FIG. 9 is a block diagram of the color signal decision circuit in FIG. 8; and

FIG. 10 is a block diagram of a video signal generator according to a third embodiment of the invention.

### DETAILED DESCRIPTION OF THE INVENTION

Embodiments of the invention will now be described with reference to the attached drawings, in which like elements are indicated by like reference characters.

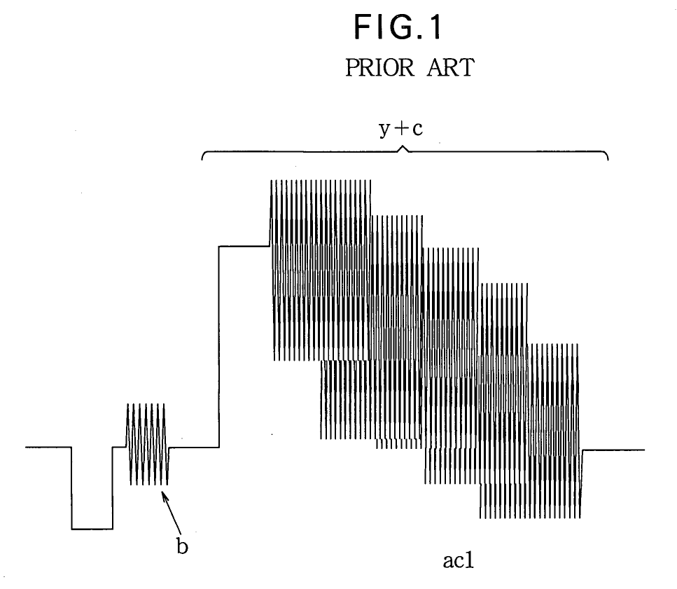

For reference, FIG. 1 shows a simplified one-line segment of a conventional analog composite video signal (ac1) including a color burst (b) followed by a chrominance signal component (c) superimposed on a luminance signal component (y). The color burst may be considered as part of the chrominance component, since both components are obtained by modulation of the same subcarrier signal (more precisely, the same pair of subcarrier signals), as will be shown below.

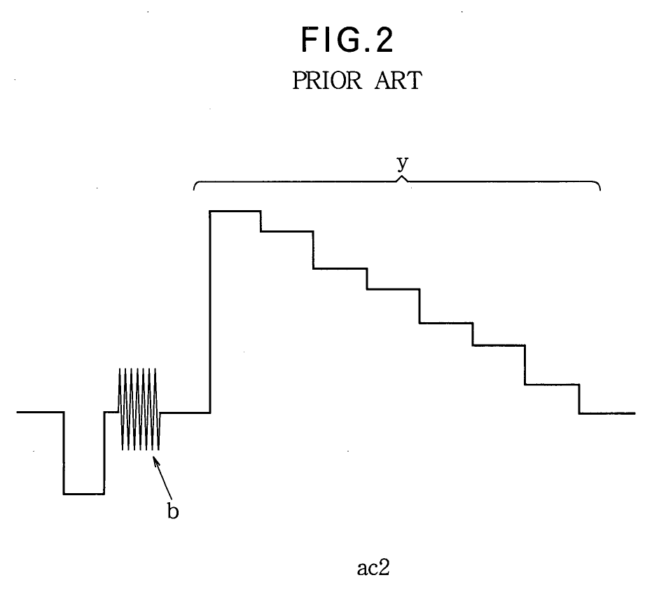

For a monochrome picture, the conventional composite video signal (ac2) has a waveform like the one shown in FIG. 2, including the luminance component (y) and still including the color burst (b), but otherwise lacking a chrominance component.

### First Embodiment

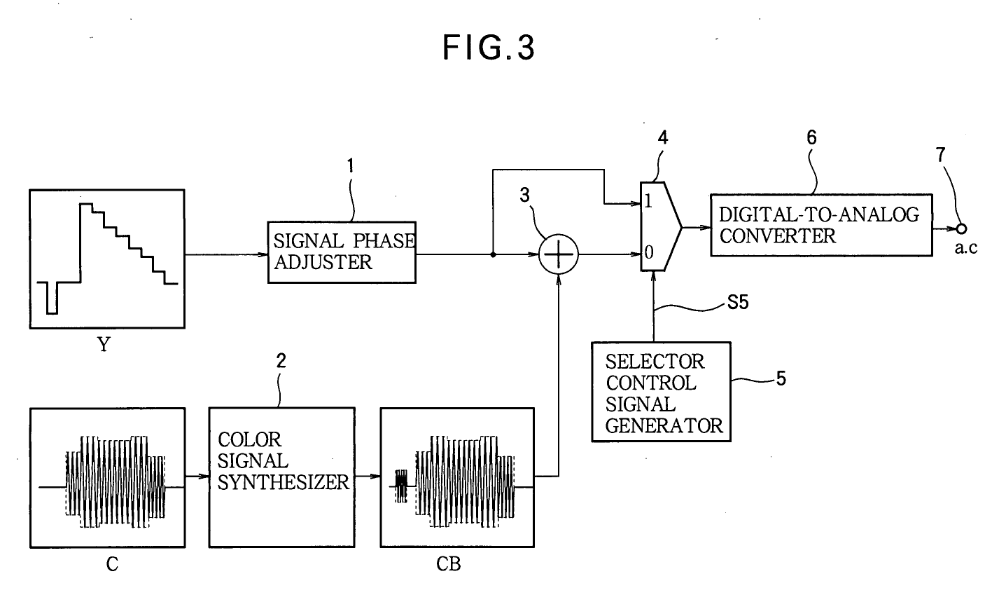

Referring to FIG. 3, the first embodiment is a video signal generator that receives a digital luminance signal Y and a digital chrominance signal C, the digital chrominance signal C including of a pair of color difference signals. A signal phase adjuster 1 comprising, for example, a plurality of flip-flops delays the digital luminance signal Y to bring it into phase with the digital chrominance signal with which it will be combined. A color burst signal synthesizer 2 generates a digital color burst signal, adds the color burst to the digital chrominance signal C, and modulates the sum onto a subcarrier signal to generate a modulated digital chrominance signal CB including a modulated color burst. An adder 3 adds the delayed digital luminance signal to the modulated digital chrominance signal. The output terminal of the adder 3 is connected to one input terminal of a selector 4; this input terminal is marked ‘1’ in the drawing and will be referred to below as the logical one input terminal. Another input terminal of the selector 4, marked ‘0’ and referred to below as the logical zero input terminal, is connected to the output terminal of the signal phase adjuster 1.

The selector 4 is controlled by a control signal S5 output from a selector control signal generator 5. When the control signal S5 is in the logical one state, the selector 4 selects the digital input signal received at the logical one input terminal; when the control signal S5 is in the logical zero state, the selector 4 selects the digital input signal received at the logical zero input terminal. The selected signal is output to a digital-to-analog converter 6. The digital-to-analog converter 6 converts the digital signal output from the selector 4 to an analog signal (ac) and outputs it to the composite video output terminal 7.

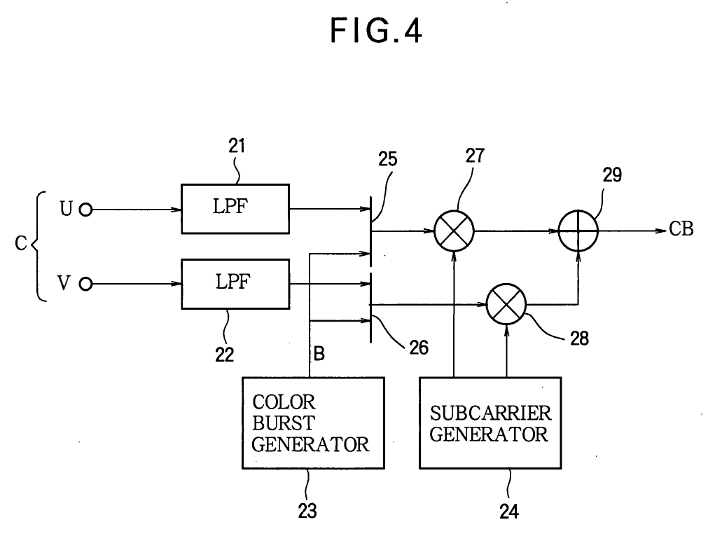

Referring to FIG. 4, the color burst signal synthesizer 2 in FIG. 3 comprises: a low-pass filter (LPF) 21 filtering high-frequency components out of one color difference signal (the U signal) constituting the chrominance signal C; an LPF 22 filtering high-frequency components out of the other color difference signal (the V signal) constituting the chrominance signal C; a color burst generator 23 generating a color burst signal B; and a subcarrier generator 24 generating a pair of subcarrier signals. The color burst signal synthesizer 2 further comprises combiners 25, 26, mixers 27, 28, and an adder 29. Combiner 25 combines the filtered U signal received from LPF 21 and the color burst signal from the color burst generator 23 into a single signal, which is sent to mixer 27. Combiner 26 combines the filtered V signal received from LPF 22 and the color burst signal from the color burst generator 23 into another single signal, which is sent to mixer 28.

Mixer 27 mixes the output signal from combiner 25 with one subcarrier output from the subcarrier generator 24, thereby modulating the subcarrier, and outputs the mixed signal to the adder 29. Mixer 28 mixes the output signal from combiner 26 with the other subcarrier output from the subcarrier generator 24 and outputs the mixed signal to the adder 29. The adder 29 adds the output signals from the mixers 27, 28 to obtain the chrominance signal CB.

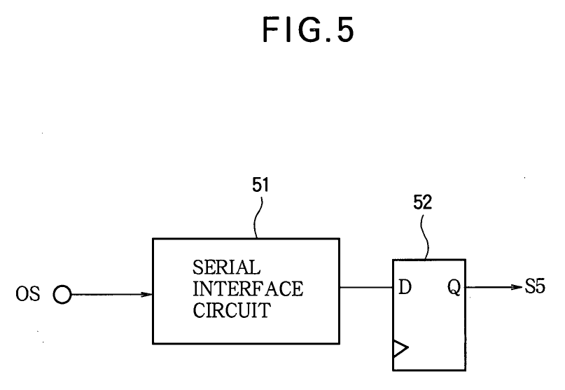

Referring to FIG. 5, the selector control signal generator 5 in FIG. 3 has a serial interface circuit 51 that receives an external input signal OS such as a color/monochrome command signal, and a latch circuit 52 such as a D-type flip-flop connected to the output terminal of the serial interface circuit 51. The latch circuit 52 receives the output of the serial interface circuit 51 and outputs the control signal S5.

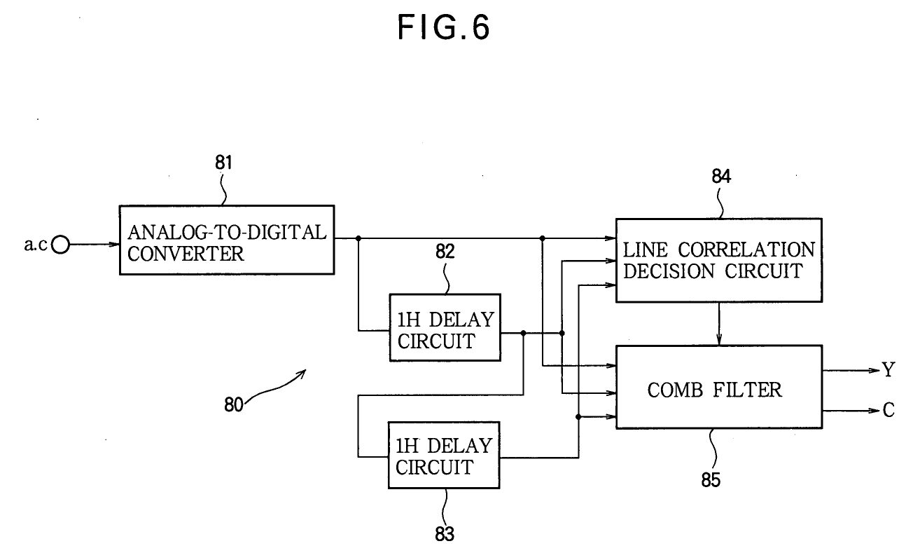

FIG. 6 shows a typical luminance/chrominance (Y/C) separation circuit 80 in the device connected to the composite video output terminal 7 in FIG. 3. The Y/C separation circuit 80 comprises an analog-to-digital converter 81, a pair of 1H delay circuits 82, 83, a line correlation decision circuit 84, and a comb filter 85. The analog-to-digital converter 81 converts the analog composite video signal (ac) input from the video signal generator to a digital signal and outputs it to the two 1H delay circuits 82, 83, which are connected in cascade. Each of the 1H delay circuits 82, 83 delays the output signal from the analog-to-digital converter 81 by one horizontal line and outputs the delayed signal to the line correlation decision circuit 84 and comb filter 85. The line correlation decision circuit 84 receives the three output signals from the analog-to-digital converter 81, 1H delay circuit 82, and 1H delay circuit 83, and determines the correlation between signal values in three consecutive horizontal lines. The comb filter 85 receives the same three outputs from the analog-to-digital converter 81, 1H delay circuit 82, and 1H delay circuit 83, separates the luminance signal Y from the chrominance signal C according to the correlation result provided by the line correlation decision circuit 84, and outputs the luminance signal Y and chrominance signal C for further processing, as a result of which, for example, a video picture is displayed on a monitor screen.

Next, the operation of the video signal generator in FIG. 3 will be described.

When a digital luminance signal Y and a digital chrominance signal C are input to the video signal generator, the signal phase adjuster 1 delays the digital luminance signal Y by a predetermined amount of time to compensate for the delay of the digital chrominance signal C in the color burst signal synthesizer 2, and sends the delayed signal to the adder 3 and selector 4. In the meantime, the LPFs 21 and 22 in the color burst signal synthesizer 2 in FIG. 4 remove high frequency components from the U and V signals constituting the chrominance signal C. The combiners 25, 26 then add a color burst signal B output from the color burst generator 23 to the filtered U and V signals. The resulting signals are mixed with subcarriers output from the subcarrier generator 24 by the mixers 27, 28, and then added to generate a chrominance signal CB including a modulated color burst signal B. The chrominance signal CB output from the adder 29 and the luminance signal output from the signal phase adjuster 1 are added by the adder 3 in FIG. 3 and sent to the selector 4.

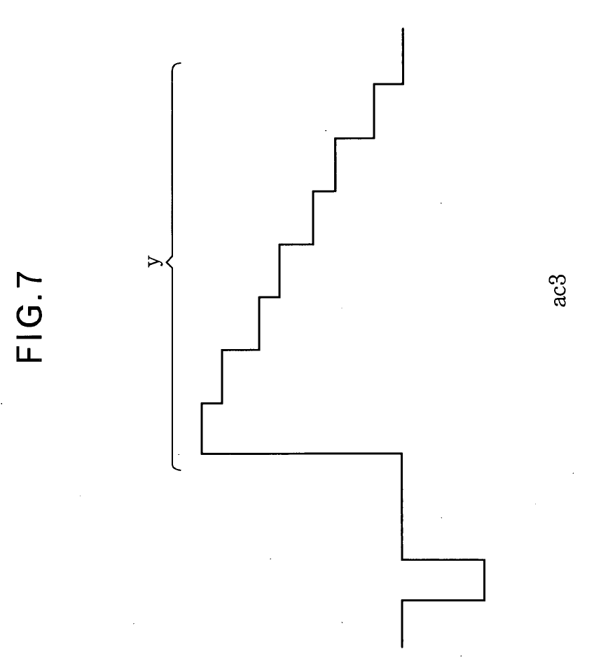

In the selector control signal generator 5 shown in FIG. 5, for example, the serial interface circuit 51 outputs a logical zero when the external input signal OS commands color video output, and a logical one when the external input signal OS commands monochrome video output. The latch circuit 52 latches the logic level output from the serial interface circuit 51 and sends it to the selector as the control signal S5. Following a color output command, accordingly, the selector 4 selects its logical zero input terminal, and the output signal from the adder 3 passes through the selector 4 to the digital-to-analog converter 6, which converts it to an analog composite video signal like the one (ac1) shown in FIG. 1. Following a monochrome output command, the selector 4 selects its logical one input terminal, and the output signal from the signal phase adjuster 1 passes through the selector 4 to the digital-to-analog converter 6, which converts it to an analog composite video signal like the one (ac3) shown in FIG. 7, having a luminance component but lacking a chrominance component and having no color burst. Regardless of whether the chrominance component is present (as in ac1) or absent (as in ac3), the analog composite video signal is output to the composite video output terminal 7.

In the receiving device connected to the composite video output terminal 7, the composite signal ac1 or ac3 is converted to a digital signal by, for example, the Y/C separation circuit 80 shown in FIG. 6, and separated into a luminance signal Y and a chrominance signal C that, for example, display a video picture on a monitor screen.

The first embodiment has a simple circuit structure, using a selector 4 to select output of a monochrome video signal or a color video signal. When a monochrome video signal is output from the composite video output terminal 7, it includes only the luminance component Y and has no color burst B, so it will not be misrecognized as a color signal by the receiving device, and no color burst has to be suppressed. If the signal is displayed as a video picture, the picture will be truly monochrome, free of color noise. When a color video signal is output from the composite video output terminal 7, a conventional composite signal (ac1) is output. Accordingly, the signal output from the composite video output terminal 7 can be correctly processed by any receiving device capable of processing a conventional analog video composite signal or, for that matter, a conventional analog monochrome video signal. In either case, monochrome video signals will be reproduced faithfully, without color artifacts.

The video signal generator in FIG. 3 may be implemented either as a semiconductor integrated circuit or by discrete circuit elements. The color burst signal synthesizer 2 in FIG. 4, the selector control signal generator 5 in FIG. 5, and the Y/C separation circuit 80 in FIG. 6 are only examples and may be modified as desired. The color-difference signals are not limited to the U and V signals mentioned above, and the input and output video signals are not limited to a particular video standard. The output analog composite video signal may conform to any standard providing a luminance component and a chrominance component.

### Second Embodiment

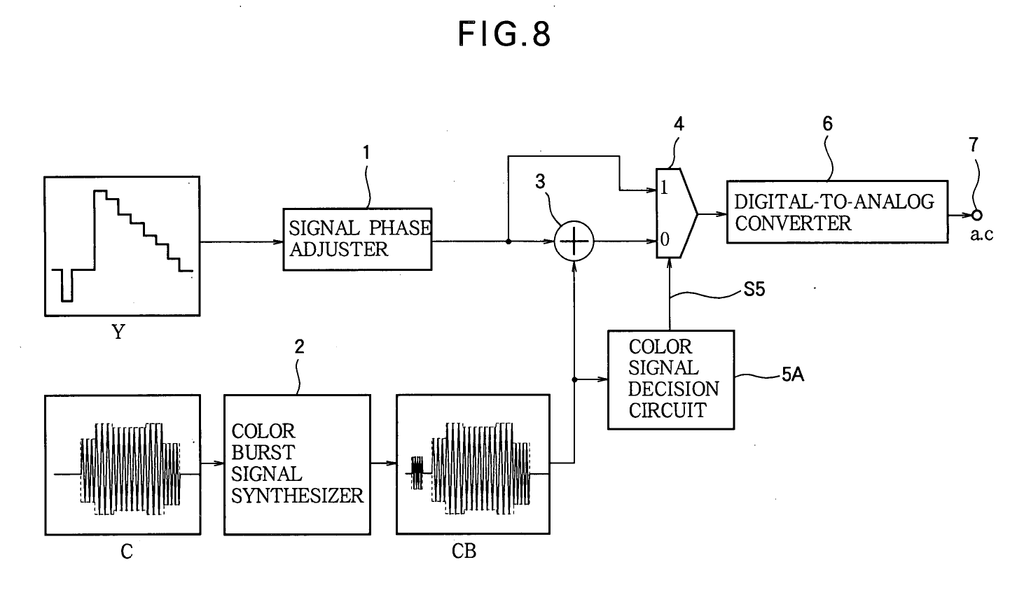

Referring to FIG. 8, the second embodiment is a video signal generator that differs from the video signal generator in the first embodiment in having a color signal decision circuit 5A in place of the selector control signal generator 5 in FIG. 3. Other structures are the same as in the first embodiment.

The color signal decision circuit 5A decides, by comparing the average amplitude of the chrominance signal CB with a threshold, for example, whether the chrominance signal CB represents a color video signal (if the average amplitude exceeds the threshold) or a monochrome video signal (if the average amplitude is less than the threshold) Instead of average amplitude, some other measure of signal strength, such as average power level or average modulation degree, may be used. The decision result is output as a control signal S5 (logical one for a monochrome signal; logical zero for a color video signal) that controls the selector 4 as described in the first embodiment.

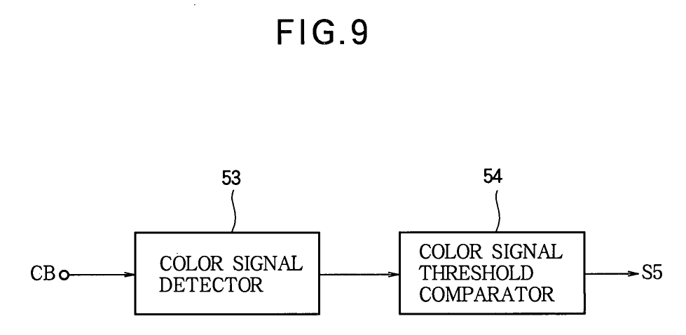

Referring to FIG. 9, the color signal decision circuit 5A comprises a color signal detector 53 and a color signal threshold comparator 54. The color signal detector 53 receives the chrominance signal CB and detects the strength of its color difference components. The color signal threshold comparator 54 decides whether the detected strength is larger than a predetermined threshold value, and outputs a control signal S5 according to the result.

Next, the operation of the video signal generator in FIG. 8 will be described.

As in the first embodiment, the signal phase adjuster 1 delays the digital luminance signal Y by a predetermined amount and sends the delayed signal to the adder 3 and selector 4. The color burst signal synthesizer 2 generates a chrominance signal CB by adding a color burst signal B to the digital chrominance signal C, and sends the sum to the adder 3 and color signal decision circuit 5A.

The color signal decision circuit 5A decides whether the chrominance signal CB includes color difference components or not. If the color signal decision circuit 5A decides that the color difference components are present (indicating a color video signal), it sets the control signal S5 to the logical zero level. If the color signal decision circuit 5A decides that the color difference components are absent or are below the threshold value (indicating a monochrome video signal), it sets the control signal S5 to the logical one level.

When the control signal S5 is a logical one (indicating a monochrome video signal), the selector 4 selects and outputs the output signal from the signal phase adjuster 1. This output signal, which includes luminance information but has no color burst, is converted to an analog signal and output from the composite video output terminal 7 as a monochrome video signal like the signal (ac3) in FIG. 7, including only a luminance component (y).

When the control signal S5 is a logical zero (indicating a color video signal), the selector 4 selects and outputs the output signal from the adder 3. This output signal, which includes a conventional chrominance signal with a color burst B, is converted to an analog signal and output from the composite video output terminal 7 as a color video signal like the signal (ac1) shown in FIG. 1.

According to the second embodiment, in addition to the effects in the first embodiment, since the color signal decision circuit 5A decides from the strength of the color difference components in the chrominance signal CB whether the video signal to be output represents a color picture or a monochrome picture, the selection operation is carried out automatically, eliminating the need for external selection control.

The video signal generator in FIG. 8 may be implemented either as a semiconductor integrated circuit or by discrete circuit elements. The color signal decision circuit 5A in FIG. 9 is only an example and may be modified as desired.

### Third Embodiment

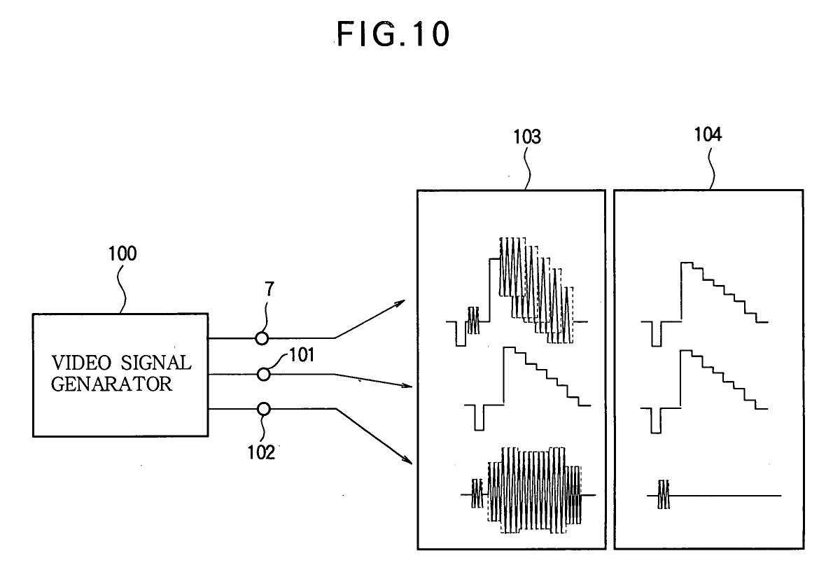

Referring to FIG. 10, the third embodiment is a video signal generator 100 that comprises the circuit in FIG. 3 or FIG. 8 and has, in addition to the composite video output terminal 7, an S-video connector with separate terminals 101, 102 for the luminance signal (output at terminal 101) and the chrominance signal (output at terminal 102). Terminal 101 is connected through an A/D converter (not shown) to the output terminal of the signal phase adjuster 1 in FIG. 3 or 8. Terminal 102 is connected through another A/D converter (not shown) to the output terminal of the color burst signal synthesizer 2. The waveforms 103 produced at the three output terminals 7, 101, 102 for a color picture differ as illustrated in FIG. 10 from the waveforms 104 produced for a monochrome picture. For a monochrome picture, the receiving device can obtain the same signal from either the composite video output terminal 7 or the S-video luminance output terminal 101.

Those skilled in the art will recognize that further embodiments and variations are possible within the scope of the invention, which is defined in the appended claims.

What is claimed is:

1. A video signal generator comprising:
an adder adding a digital luminance signal to a digital chrominance signal including a color burst to obtain a digital composite video signal;
a selector receiving the digital luminance signal, the digital composite video signal, and a control signal selecting monochrome or color output, outputting the digital luminance signal when the control signal selects monochrome output, and outputting the digital composite video signal when the control signal selects color output;
a digital-to-analog converter converting the signal output from the selector to an analog signal; and
a composite video output terminal for output of the analog signal.

2. The video signal generator of claim 1, further comprising a decision circuit receiving the digital chrominance signal and generating the control signal by measuring a strength of color components in the digital chrominance signal, deciding from the measured strength whether the digital chrominance signal represents a color picture, setting the control signal to a first value selecting color output if the digital chrominance signal represents a color picture, and setting the control signal to a second value selecting monochrome output if the digital chrominance signal does not represent a color picture.

3. The video signal generator of claim 2, wherein the decision circuit compares the measured strength with a threshold value, sets the control signal to the first value if the measured strength exceeds the threshold value, and sets the control signal to the second value if the measured strength is less than the threshold value.

4. The video signal generator of claim 1, further comprising a control signal generator receiving an external command signal designating monochrome or color output and generating the control signal.

5. The video signal generator of claim 5, wherein the control signal generator comprises:
an interface for converting the external command signal to a logic level; and
a latch for latching the logic level.
